(19) United States
(12) Patent Application Publication
(10) Pub. No.: US 2019/0325452 A1
(43) Pub. Date: Oct. 24, 2019

(54) Computing Device and System with Biometric Verification, a Hotel Server, and an Exchange Server

(71) Applicant: Michael Farjami, Laguna Hills, CA (US)

(72) Inventor: Michael Farjami, Laguna Hills, CA (US)

(21) Appl. No.: 16/377,677

(22) Filed: Apr. 8, 2019

Related U.S. Application Data
(60) Provisional application No. 62/659,896, filed on Apr. 19, 2018.

(51) Int. Cl. G06Q 20/40; G06Q 30/06; G06Q 10/02; G06Q 50/14; G06Q 50/12

(52) U.S. Cl. CPC G06Q 20/40145; G06Q 30/0641; G06Q 50/12; G06Q 50/14; G06Q 10/02

(57) ABSTRACT

A computing device is disclosed wherein the computing device includes a graphical user interface having a graphical display of a plurality of travel and/or stay packages, a graphical display of a wallet, a graphical display for biometric data input/verification, wherein the computing device is configured to communicate with a smart contract exchange. The wallet includes a wallet graphical user interface, the wallet graphical user interface including a graphical display for purchased travel and/or stay packages, a graphical display for unused items in purchased travel and/or stay packages, a graphical display for filtered travel and/or stay packages, a graphical display for an available bank account, and a graphical display for an available cryptocurrency account. Further disclosed is a system including a computing device having a biometric verification input, a hotel server, and an exchange server.

The present application claims the benefit of and priority to a provisional patent application entitled “System Including a Computing Device with Biometric Verification Tools, a Hotel Server, and an Exchange Server”, Ser. No. 62/659,896 filed on Apr. 19, 2018. The disclosure in that provisional application is hereby incorporated fully by reference into the present application.

### BACKGROUND

Presently, a prospective customer (i.e. a user) purchasing a travel package runs the risk of losing at least a portion of the price paid for the travel package if the package is canceled or unused. Moreover, due to currency fluctuations, the value of a travel package purchased from an overseas seller (e.g. an overseas hotel), may be dependent on currency exchange rates. Also, there is no easy or convenient way for a purchaser to “cash out” a travel package either for profit or simply because the travel package can no longer be used by the purchaser. Further, a business establishment, such as a hotel, may not be able to receive regular and accurate feedback on the value of its travel packages. In addition, it may be difficult to verify the present ownership of the travel package. Also, during use of each travel package, the purchaser (i.e. the user) may need to be advised on a continuous basis how much of a travel package remains to be used.

The present application provides a novel system including a computing device with biometric verification, a hotel server, an exchange server, and a smart contract engine that overcome the deficiencies in the art.

### SUMMARY

The present disclosure is directed to a system including a computing device with biometric verification inputs, a hotel server, and an exchange server, substantially as shown in and/or described in connection with at least one of the figures, and as set forth in the claims.

### BRIEF DESCRIPTION OF THE DRAWINGS

FIG. 1 illustrates an exemplary system including a hotel server in communication with a computing device, and with a smart contract exchange according to one implementation of the present application.

FIG. 2 illustrates a smart contract exchange according to one implementation of the present application.

FIG. 3 illustrates an exemplary smart contract engine according to one implementation of the present application.

FIG. 4 illustrates an exemplary wallet for use in the computing device of FIG. 1.

### DESCRIPTION OF EXEMPLARY IMPLEMENTATIONS

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

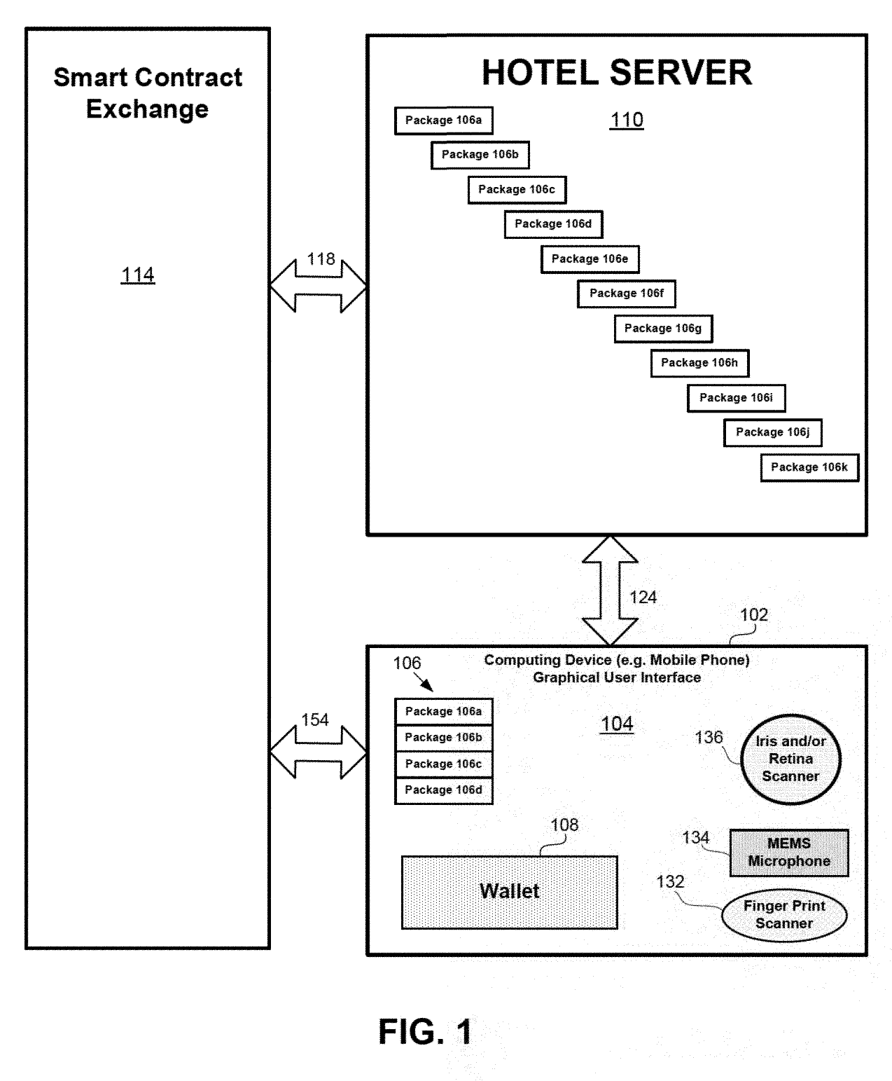

Referring to FIG. 1, the user-side system and interface comprise a computing device, such as a mobile phone, a smart watch, a laptop computer, a desktop computer, or a web-enabled TV, and in general any computing device that can be connected wirelessly (through WiFi, 4G, 5G, etc. . . . ), or by wire (through cables, fiber optics, POTS (Plain Old Telephone Service) wires, DSL (Digital Subscriber Line) wires, etc.). The user-side computing device is utilized, among other things, for displaying and employing a graphical user interface. The graphical user interface and its functions are described further below.

An exemplary user-facing computing device, such as a mobile phone 102, is shown in FIG. 1. In one implementation the user-facing computing device, in this example mobile phone 102, includes a graphical user interface that displays a merchant's web site, such as a hotel's (or a hotel chain's) web site 104. In the present application, “computing device” 102, “mobile phone” 102, may interchangeably refer to a “graphical user interface” which may also be referred to as “graphical user interface” 102 in the present application. Within hotel's web site 104 displayed by the graphical user interface of mobile phone 102 is a listing of travel and/or stay packages offered by the hotel. For the purpose of brevity each travel and/or stay package may also be referred to as a “travel/stay package,” a “travel package,” a “stay package,” or simply a “package.” Thus, hotel's web site 104 displays numerous travel and/or stay packages of which only a few are shown by way of examples, such as travel/stay package 106a, travel/stay package 106b, travel/stay package 106c, and travel/stay package 106d, while numerous other packages not shown in FIG. 1 (travel/stay packages 106a, 106b, etc. . . . may be referred to herein collectively as travel/stay packages 106 for ease of reference). A user can view the numerous travel and/or stay packages by scrolling down or turning pages on web site 104 in a manner known in the art.

In one implementation digital wallet 108, also simply referred to as wallet 108, is graphically displayed along with other information on the display of mobile phone 102 through the graphical user interface of the mobile phone. In one implementation, wallet 108 may be graphically displayed along with web site 104 if hotel's web site 104 or hotel's server 110 has access to or has stored therein wallet 108. In this implementation, regardless of which of his/her computing devices the user is using, the wallet appears as part of a customized web site 104 rendering to the user. In another implementation, the wallet is only stored within mobile phone 102 and is displayed by mobile phone 102; in this implementation the contents of wallet 108 are not, or are not fully, shared with hotel's web site 104 or hotel's server 110.

Through secure communication protocol/channel 124, each travel and/or stay package 106 is received from server 110 which contains, among other things, all or some of the travel and/or stay packages offered by the hotel. Each package can represent a travel and/or stay package offered by the hotel to the user (i.e. a prospective purchaser, such as a consumer, a travel agency, or another business). For example, package 106a corresponds to four nights stay at the Grand Hotel from Dec. 1, 2020 to Dec. 4, 2020. Package 106b corresponds to four nights stay from Apr. 10, 2021 to Apr. 14, 2021 plus one dinner for two plus two boat trips along the shore. Package 106c corresponds to three nights stay from Jun. 15, 2022 to Jun. 18, 2022, plus three breakfasts for two and a one-hour spa session. Of course these packages can have and be offered with numerous variations, and in some implementations can also include air travel (or land or sea travel) tickets.

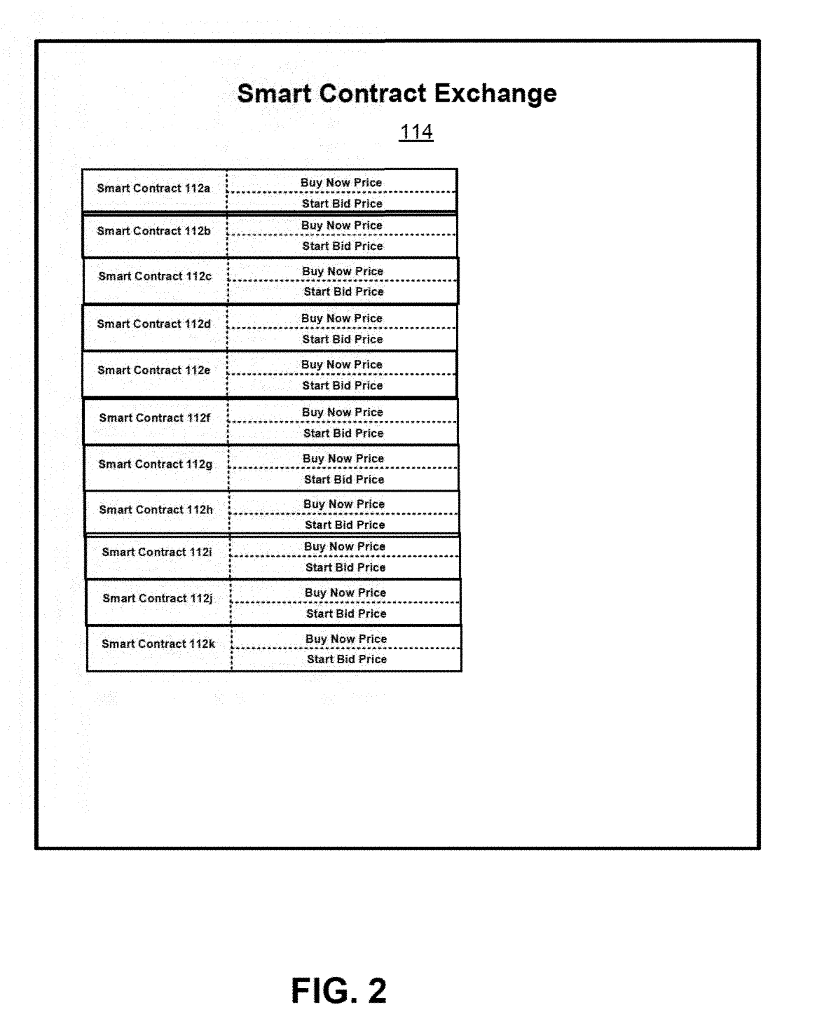

A common feature of these packages is that the date of use is generally pre-set. In other words, the travel and/or stay package need be used at a certain date in the future. The basic package information, along with key features, such as the authorized (or actual) date of use, for example, Dec. 1, 2020 for package 106a, is stored in a corresponding smart contract, such as smart contract 112a (FIG. 2), that represents a particular package, for example, package 106a. Similarly, smart contract 112b represents package 106b, and its use date of Apr. 10, 2021, and smart contract 112c represents package 106c and its use date of Jun. 15, 2022. In one implementation of the present application, smart contract standards such as ERC-721 non-fungible token standard or ERC-1155 reference implementation may be used to guarantee the authenticity of the smart contracts. For various reasons, it is preferable to utilize smart contracts in various implementations of the present application. For example, smart contracts allow users to be confident that they are receiving authentic contracts since they are tethered to the blockchain.

In a manner discussed below, the farther away the actual or authorized use date of each package 106 is, the greater discount that the corresponding smart contract calculates for the package. As a package gets closer to the actual use date, the smart contract reduces the discount calculated for the package, which tends to increase the price of the package (the price of the package will depend on a number of other factors, other than how far the actual use date of the package is in the future, as discussed below). The price of the smart contract can be calculated and made available in either fiat money (e.g., by using credit cards based on fiat money or debit cards accessing fiat money bank accounts) or cryptocurrency (e.g., by use of digital wallets or debit cards accessing cryptocurrency accounts).

Utilizing cryptocurrency to calculate the price of the smart contract (for sale, purchase, or assignment), as well as for trading on smart contract exchange 114 has certain advantages. First, there is an advantages due to the decentralized operation of cryptocurrencies where no third party (such as a bank or other financial institution) need be involved and no trust in the third part need be had (e.g., there would be no need to trust a financial institution that may not be reliable, credible, or has financial liquidity problems). Second, because no third party, such as a bank, is needed, transaction fees can be significantly smaller. Third, there is generally a higher security level since it is extremely difficult to intercept cryptocurrencies being transferred to purchase smart contracts relative to intercepting credit card numbers and bank account information and misappropriating same. Fourth, there would be no need to incur currency exchange risks. For example, using fiat money, a hotel in New York getting paid by a consumer making a booking using Japanese Yens is subject to currency fluctuations and risks that are absent when using cryptocurrency (in other words, the timing of the booking affects the U.S. Dollar amount that results from conversion of Yens into U.S. Dollars).

Smart contracts available on the smart contract exchange, shown by exemplary smart contract 112a, and smart contracts 112b through 112k in exchange 114 in FIG. 2, can be written in a programming language such as Solidity, Serpent, LLL, and Viper that are also suitable for supporting a cryptocurrency whose blockchain is generated on the same platform as the smart contract and with the same programming language. This creates added efficiency and a more secure environment for the smart contract and its financial value as expressed by the cryptocurrency using the same platform as the smart contract, and would present another advantage of using cryptocurrency instead of fiat money to purchase or sell the smart contracts on exchange 114.

Moreover, it is easier for a smart contract to calculate its price based on cryptocurrencies that are backed by hotel packages, instead of based on fiat money that is backed by assets that are not directly related to the actual underlying asset that the smart contract represents, in that the asset backing the smart contract (e.g., the hotel package) is the inherent value of the use of hotel's services and goods. Thus, cryptocurrency can have a more aligned and a more direct relation with the value of the smart contract as compared with fiat money whose value moves for other reasons, for example, monetary policy, inflation rate, interest rate, currency exchange rates and/or credit quality.

Each package price (or package value) is calculated by the smart contract engine as discussed further below, and preferably the price is based on cryptocurrency backed by the hotel package, as opposed to fiat money (although purchasers can choose to pay for the package by fiat money as well). The value of fiat money can vary based on, for example, currency exchange rates and inflation, and is sometimes inadequately backed by assets or governments. However, the cryptocurrencies used for the purpose of trading on smart contract exchange 114 are backed by the values of the packages that are inherently valuable as each smart contract's value (and thus its price) is backed by the underlying package, that is the underlying services and goods offered by the hotel at a certain date. In other words, the value of services and goods offered by the hotel backs the value of the cryptocurrency, and not the value of the fiat money at the time of the purchase of the smart contract, which can be very different from the value of the fiat money at the time of the actual use of the contract that is scheduled for some time in the future.

For example, if package 106a offered by a hotel in New York is purchased by Japanese Yens in April 2018 based on an exchange rate of 100 Yens to a Dollar, and on Dec. 1, 2020 (the actual use date of the package), the exchange rate is 120 Yens to a Dollar, and the general inflation has been 3% per year, the hotel has effectively lost more than about 26% on the sale of the package if the package was sold in Japanese Yens in April 2018 (that is 20% loss due to exchange rate variation plus more than 6% due to inflation at 3% per year). However, a cryptocurrency backed by the hotel's package, fluctuates only according to the inherent worth of the package based on the inherent desirability of the package at any given point in time; for example, the desirability and reputation of the particular hotel's goods and services, and how close the actual use date is to the date of the purchase of the package, and a number of other very relevant factors used by the smart contract engine, as opposed to changes in the currency exchange rate and general inflation rate that are not very relevant to the desirability of the package as viewed by a prospective purchaser or a consumer of the package.

As shown in FIGS. 1 and 2, exchange 114 receives information containing features and characteristics of packages 106a, 106b, 106c, etc. . . . from hotel server 110 through secure communication protocol/channel 118, and converts them into smart contracts (or “crypto contracts”) 112a, 112b, 112c, etc. . . . so that each smart contract can be listed on exchange 114. By way of background, a smart contract, also known as a crypto contract, is a computer program that, among other things, controls the transfer of digital currencies or assets between parties under certain conditions. A smart contract not only defines the rules and penalties around an agreement in the same way that a traditional contract does, but it can also automatically enforce those obligations. It does this by taking in information as input, assigning value to the inputs through the rules set out in the contract, and executing the actions required by contractual clauses—for example, determining whether an asset should go to one person or returned to the other person from whom the asset originated. One rule can be adjustment of the price of the contract for sale of underlying services and goods of the hotel based on how far in advance of the actual use date of services or transfer of goods the contract is purchased. Smart contracts are stored in blockchain technology, a decentralized ledger that also underpins various cryptocurrencies. Blockchain is often preferred for storing smart contracts because of the technology's security and immutability.

According to one implementation of the present application, smart contracts are programmed with rules that determine the price of a travel and/or stay package based on the number of days remaining to the actual use date of the package. The closer to the actual use date, the discounted price is further reduced, i.e. the smart contract purchase price is increased. In one implementation the smart contracts can be written using the programming language Solidity, which is used for implementing smart contracts on various blockchain platforms. Other programming languages, such as Serpent, LLL, and Viper, may also be used.

In one implementation, smart contract exchange 114 can be built around any programming language for smart contracts that runs on Ethereum Virtual Machine (EVM) on blockchain. Thus, the hotel packages existing on server 110 can be communicated to exchange 114 through secure connection protocol 118. In one implementation, secure protocol 118 is known and shared only between server 110 and exchange 114, and is not an IP protocol or other publicly known protocol for communication between two computers. The non-IP protocol used by secure connection 118 is a protocol known only to an administrator or operator of exchange 114. In one implementation, the non-IP protocol also avoids using SSH (Secure Shell (SSH) is a network protocol for operating network services securely over an unsecured network) or common network communication protocols. In one implementation, the non-IP protocol used by secure connection 118 can be a custom network communication protocol developed by an administrator or operator and based on a less common network communication protocol, such as Internetwork Packet Exchange (IPX) or Recursive InterNetwork Architecture (RINA). In one implementation, the non-IP protocol used by secure connection 118 can be an entirely custom network communication protocol developed by the administrator or operator.

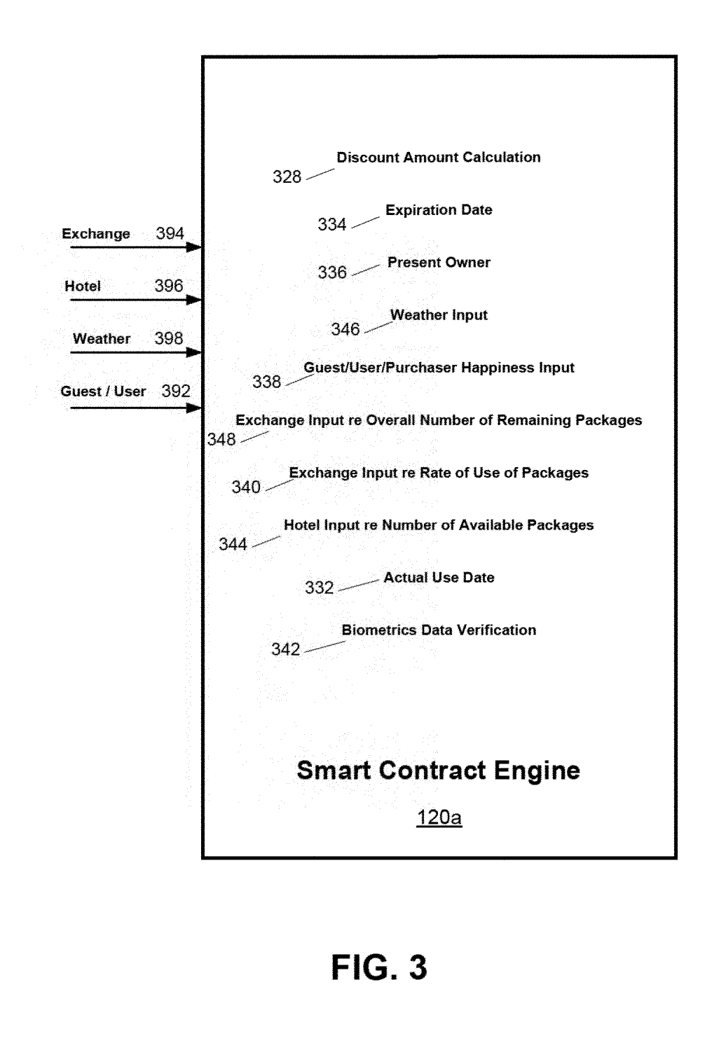

Referring to FIG. 2, each smart contract, such as smart contracts 112a, 112b, 112c, includes or references a data structure and an algorithm that is executed on the blockchain. Referring to FIG. 3, exemplary smart contract engine 120a corresponds to smart contract 112a and shows a data structure that includes, among other things, price discount amount calculation module 328, wherein the calculated discount amount of the price can be based on two groups of factors. A first group of factors includes general factors that reflect, for example, how far in advance of the actual use date the travel and/or stay package is purchased. Other general factors in the first group are weather forecasts for purchases that are made close enough to the actual use date such that weather can be taken into account in initial price adjustment or secondary market price adjustment. A second group of factors corresponds to specifics that are unique to the purchaser. For example, whether the purchaser is part of a loyalty discount program of a hotel chain or an airline, whether the purchase was made as part of a special season sale, or as part of a group discount, whether the sale was accompanied by the purchaser presenting a special discount coupon, and whether the purchaser is a wholesale purchaser (such as a travel agency or another company) as opposed to a retail purchaser.

Each general factor, according to the data structure of each smart contract, is associated with a typically pre-set (fixed) factor of importance and a variable value. The smart contract continuously applies the pre-set importance factor to each variable value for each general factor. For example, if importance of length of time between actual use date and contract purchase date is 1.5, and the length of time from the actual use date is less than 3 months (a value of 1), as opposed to greater than 3 months (a value of 0), then a value of 1*1.5 (i.e. 1.5) is assigned to the actual use date general factor. Similarly, if importance value of a loyalty program is 0.8 and there is a loyalty program in place, i.e. a value of 1 (as opposed to a value of 0 when no loyalty program is in place), then a value of 1*0.8 (i.e. 0.8) is assigned to the loyalty program general factor. Thus, the sum of the actual use date general factor and the loyalty program general factor would be 2.3 (i.e. 1.5+0.8). The data structure of each smart contract may also include a typically pre-set (fixed) values for specific factors that do not have a variable associated with them.

Among information held in the data structure of smart contract engine 120a are actual use date 332, expiration date 334 after which the contract cannot be traded, identifying information about the present owner 336, including biometric information, such as finger print scans, and ocular-based identification such as retina and iris scans, and voice verification information as further discussed below.

Thus, according to one implementation of the present application, each smart contract, such as smart contract 120a, holds a data structure and a calculation engine that, among other things, continuously calculates and results in present values and verified ownership information that get listed on exchange 114 as part of the information associated with each travel and/or stay package and represented by each corresponding smart contract.

As shown in FIG. 2, each smart contract 112a, 112b, 112c, etc. . . . , can be traded either as “buy now” by using the price engine output of the smart contract. The “buy now” price may be updated once daily (or more or less frequently). Alternatively, the smart contract can be subject to bidding by using the “start bid” option shown in FIG. 2 and setting a minimum bid (and possibly a maximum bid as well as a maximum final purchase price), and applying a bidding method of choice. In one bidding approach, the smart contract itself determines the minimum bid (and potentially a maximum final purchase price), and the smart contract itself accepts a bid and closes the bidding process based on various factors, such as frequency of bidding (e.g., how many bids per hour are being submitted), the time lapse since the last bid was submitted and the last bid amounts, and/or a final closing time (i.e. a deadline) that may be pre-set and announced by the smart contract prior to the initiation of bidding.

In one implementation, the procedure to complete a sale, i.e. a change of title in the smart contract, to a new purchaser on the exchange requires saving new biometric information. For example, the sale might require scanning finger prints, or irises or retinas or voice samples of the seller and/or the purchaser. These steps may be performed by the “biometrics data verification” module 342 in smart contract engine 120a shown in FIG. 3. Further, use of the contract (for example, use at the hotel on the actual use date) may require unlocking the contract by verifying, among other things, the stored biometric information. Furthermore, by storing verifiable biometric information, further price discounts can be calculated for a retail purchaser as the number of purchases are increased over time, since the retail purchaser is easily identified and verified by his/her biometric information. Thus, biometric data is a factor in the smart contract price calculation for a travel/stay package. Another factor in smart contract pricing is that the continuous communication between exchange 114 and hotel server 110 through secure communication protocol/channel 118 would result in recognizing when the number of available hotel packages have significantly decreased or increased, which would then result in an increase or decrease in the smart contract price by the smart contract calculation engine.

Referring again to FIG. 1, computing device 102, for example mobile phone 102, includes biometric identification devices, tools, or inputs such as finger print scanner 132, MEMS microphone 134, and iris and/or retina scanner 136. Iris and/or retina scanner 136 is an example of biometric data input/verification function or module of mobile phone 102, and is graphically displayed as an icon or a display area 136 by graphical user interface 102 of the mobile phone. Similarly, finger print scanner 132 and MEMS microphone 134 are examples of biometric data input/verification functions or modules of mobile phone 102, and are graphically displayed as icons or display areas 132 and 134, respectively, by graphical user interface 102 of the mobile phone.

The biometric identification devices or inputs are utilized to verify the identity of a seller, purchaser, or user of the smart contract in a manner discussed above. Further, mobile phone 102 displays wallet 108. Wallet 108 stores and displays, upon demand, smart contracts that the purchaser has already bought as well as including a capability and a graphical user interface to present information from exchange 114 to the purchaser or user. Wallet 108 also keeps track of the portion of a travel and/or stay package that is used and the portion that is not used. For example, wallet 108 can display that one night of stay is completed, and two more nights of stay remain, or two dinners have been used, and three dinners remain, or one spa session has been used, and one spa session remains, etc. . . . , as an easy way to keep track of a travel and/or stay package offered by a hotel or an airline. As discussed below, “remaining (unused) items in purchased packages” 414 in wallet 408 can be used for this purpose.

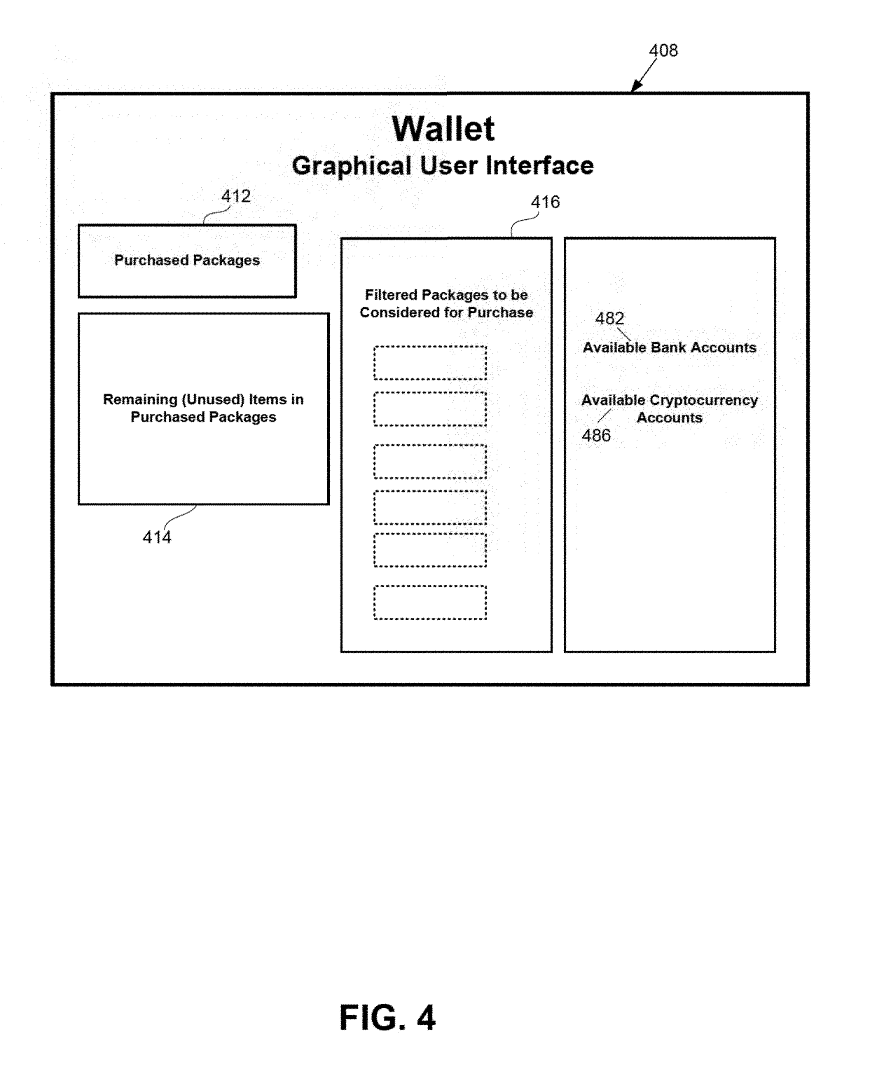

Moreover, wallet 108 can be customized to show smart contracts of interest (for example, smart contracts corresponding to packages 106a, 106b, 106c, 106d, etc. . . . ) through a filter that passes most relevant and most desirable travel and/or stay packages to the user by directly interfacing with exchange 114 through secure communication protocol/channel 154. In one implementation, the data provided by the exchange can be passed onto and displayed on mobile phone 102 by communication with server 110 through secure communication protocol/channel 124 which is in turn communicating with exchange 114 through secure communication protocol/channel 118, while in another implementation such data can be passed onto and displayed on mobile phone 102 by direct communication between mobile phone 102 and exchange 114 through secure communication protocol/channel 154. The filter can display information on wallet 108 by applying an algorithm that prioritizes listings based on user preferences and characteristics, such as user's age, price range of interest, location of the hotel, time of actual use of the package, and other criteria that the user or purchaser determines is important to him/her. The user can also designate the importance of each such factor or criterion in a manner such that the filter also takes into account the relative weight to be applied to each preference. FIG. 4 shows one exemplary implementation of wallet 108 of FIG. 1, shown as wallet 408 in FIG. 4. Wallet 408 is shown using one exemplary implementation of its graphical user interface, also referred to as the wallet graphical user interface in the present application. In this implementation, wallet 408 can process and host a graphical display for “purchased packages” 412, a graphical display for “remaining (unused) items in purchased packages” 414, and a graphical display for “filtered packages to be considered for purchase” 416. Other items that can be graphically displayed in this implementation of wallet 408 are a graphical display for “available bank accounts” 482 and a graphical display for “available cryptocurrency accounts” 486. As discussed above, using cryptocurrency accounts can provide certain advantages in one implementation of the present application.

Referring to smart contract engine 120a in FIG. 3, some exemplary inputs to the calculation engine include a guest/purchaser/user happiness input 338, which can be communicated smart contract engine 120a by, for example, pushing buttons numbered 1 (least happy) to 5 (most happy) inside each hotel room, and connected wirelessly or by wire to server 110, and in turn provided to smart contract engine 120a by guest/user communication channel 392. In one implementation, server 110 communicates the guest/purchaser/user happiness input to exchange 114, which in turn communicates this input to smart contract 112a and its engine 120a via guest/user communication channel 392.

Other inputs to smart contract engine 120a are rate of use of similar contracts by purchasers shown as “exchange input re rate of use of packages” 340 which is communicated to smart contract engine 120a via exchange channel 394. This input provides, among other things, a measure of present consumer demand for similar packages, which is a factor in the desirability of similar packages and would affect the price of each package on the secondary market supported by exchange 114.

Another input to smart contract engine 120a is “exchange input re overall number of remaining packages” 348 which is also communicated to smart contract engine 120a via exchange channel 394. This input provides, among other things, remaining contracts with similar features (e.g., same or similar hotel, same or similar actual use dates, and same or similar number of nights), i.e. a measure of competitive and substitute offerings, which is a factor in the desirability of similar packages and would affect the price of each package on the secondary market supported by exchange 114.

Hotel input regarding number of available offers is also another input to smart contract engine 120a, that is shown as “hotel input re number of available packages” 344. In one implementation, this input is received from hotel communication channel 396. As stated above, when actual use date is close for weather forecast (for example, within fifteen days), weather input 346 will also be used to adjust the price of the smart contract. In one implementation, this input is received from weather communication channel 398. Another input to the calculation engine would be a measure of other user reviews of similar packages offered by the same hotel, also ranging from 1 (least happy) to 5 (most happy). In one implementation this input is provided by guest/user communication channel 392, and is considered by “guest happiness input” module 338 as a factor in calculating the price of a particular smart contract (e.g., the price of a particular hotel package).

One significant and user-visible result of the determinations made by smart contract engine 120a is to display the present price of the contract via the “buy now price” button on exchange 114 as shown in FIG. 2 (which can also be displayed as “buy now” price on wallet 108). Another significant user-visible result would be to display the appropriate bidding price and other bidding parameters of the smart contract via the “start bid price” button on exchange 114 as shown in FIG. 2 (which can also be displayed as “start bid” price on wallet 108).

In summary, and to recite some benefits flowing from the above inventive concepts, according to various implementations of the present application, smart contracts are backed by services, goods, and offerings of a hotel. The hotel offers various packages (e.g., 4 nights stay, or 4 nights stay+2 dinners+2 boat trips+1 spa use, etc. . . . ). The smart contracts are backed by these services, goods, and room offerings. The further out in the future the actual use date of a package, the greater discount at which the smart contract representing the package is initially sold to the public by the hotel (sold in either cryptocurrency or fiat money, but preferably crypto currency). The smart contract and the cryptocurrency or fiat money can be conveniently stored in a wallet on the user's phone for purchase and/or trading the hotel packages.

The user can “cash out” by using the hotel services and goods in the stated future date, or by offering the smart contract on an exchange which can be, for example, promoted by and linked to by the hotel since the hotel is interested in a liquid market for all its future offerings, i.e. a liquid secondary market even though the hotel has already received cash for its future offerings in the initial sale of the smart contract. Also, the hotel will be motivated to improve its rooms, resort features, and services since the price of its smart contract in the secondary market can go higher by good reviews and good word of mouth, which would then result in higher prices for the hotel's initial offerings of additional hotel packages. As a corollary, a downward price movement of the hotel's packages (i.e. a downward price movement in the smart contracts representing the hotel packages), provides quick and true feedback to the hotel as to whether it needs to improve its services, operations, packages, etc. . . .

The smart contracts and cryptocurrency used to trade the smart contracts have features of being “asset backed” (i.e. by rooms and services of the hotel), they will be more convenient to use than gift certificates or debit cards, they have trading features that are very difficult to implement without smart contracts, they encourage the hotels to improve, they provide a liquid market such that people are more willing to buy packages well out in the future since they can more easily sell their packages if they change their travel plans (or even just for the purpose of a profit). The smart contract can interact with a user's wallet and provide transparency to hotel guests as to exactly what in their package is left unused (e.g., the guest has one more dinner and one more boat trip remaining).

From the above description, it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A computing device comprising:
a graphical user interface including:
a graphical display of a plurality of travel/stay packages;
a graphical display of a wallet;
a graphical display for biometric data input/verification;
said computing device being configured to communicate with a smart contract exchange.

2. The computing device of claim 1, wherein said computing device is selected from the group consisting of a mobile phone, a smart watch, a laptop computer, a desktop computer, and a web-enabled TV.

3. The computing device of claim 1, wherein said computing device is configured to communicate with said smart contract exchange by a wireless connection selected from the group consisting of WiFi, 4G, LTE, and 5G.

4. The computing device of claim 1, wherein said computing device is configured to communicate with said smart contract exchange by a wireline connection selected from the group consisting of cables, fiber optics, POTS (Plain Old Telephone Service) wires, and DSL (Digital Subscriber Line) wires.

5. The computing device of claim 1, wherein said computing device is further configured to communicate with a hotel server.

6. The computing device of claim 1, wherein said wallet includes a wallet graphical user interface, said wallet graphical user interface including a graphical display for purchased travel/stay packages and a graphical display for unused items in purchased travel/stay packages.

7. The computing device of claim 6, wherein said wallet graphical user interface further includes a graphical display for filtered travel/stay packages, and a graphical display for an available bank account, and a graphical display for an available cryptocurrency account.

8. The computing device of claim 1, wherein said smart contract exchange hosts at least one smart contract, wherein said at least one smart contract includes an engine that determines the price of said smart contract based on at least one factor, said at least one factor being selected from the group consisting of a travel/stay package actual use date factor, and a weather factor.

9. The computing device of claim 1, wherein said smart contract exchange hosts at least one smart contract, wherein said at least one smart contract includes an engine that determines the price of said smart contract based on at least one factor, said at least one factor being selected from the group consisting of a biometric data factor and a travel/stay package expiration date factor.

10. The computing device of claim 1, wherein said smart contract exchange hosts at least one smart contract, wherein said at least one smart contract receives inputs from a hotel server.

11. A system comprising:
a computing device including a biometric verification input;
a hotel server;
an exchange server;
said exchange server include a plurality of smart contracts, at least one of said plurality of smart contracts including a corresponding smart contract engine, wherein said smart contract engine is coupled to and communicates with said exchange server and said hotel server;
wherein said smart contract engine receives input from said exchange server and said hotel server to determine a present value of said smart contract;
said computing device being capable of displaying said present value of said smart contract.

12. The system of claim 11, wherein the computing device further includes a wallet for displaying said present value of said smart contract.

13. The system of claim 11, wherein said smart contract engine further receives a weather input.

14. The system of claim 11, wherein said smart contract engine further receives a guest/user input.
